(19) United States
(12) Patent Application Publication
(10) Pub. No.: US 2004/0193602 A1
(43) Pub. Date: Sep. 30, 2004

(54) Method and system for maintenance of engineering change data

(76) Inventors: Chiu-Juan Liu, Taipei (TW); Li-Hua Lee, Taipei (TW); Hui Lan Peng, Taipei (TW); Chien-Miug Tseng, Taipei (TW); Kuang-Yu Peng, Taipei (TW); Jui-Kuang Wei, Taipei (TW)

Correspondence Address: FULBRIGHT AND JAWORSKI L L P, PATENT DOCKETING 29TH FLOOR, 865 SOUTH FIGUEROA STREET, LOS ANGELES, CA, 900172576

(21) Appl. No.: 10/401,394

(22) Filed: Mar. 28, 2003

(51) Int. Cl. G06F 7/00

(52) U.S. Cl. 707/9

(57) ABSTRACT

A method and a system for maintenance of engineering change data are provided. A form generation module generates an electronic form for maintenance of engineering change data according to access rights and search conditions input from a user via a terminal device. A verification module compares engineering data before and after being modified by the user to determine if engineering data, unexpected to be changed, are modified by the user; if yes, the verification module generates an alert message to confirm this modification with the user. A transfer module transfers the electronic form with the engineering change data to an associated responsible unit for verification and approval. A maintenance module updates and upgrades version of engineering data in a database and a backend data processing system once the engineering change data are verified and approved. By the above method and system, operational errors and invalid data modification are eliminated.

### FIELD OF THE INVENTION

The present invention relates to methods and systems for maintenance of engineering change data, and more particularly, to a method and a system for maintaining engineering change data through the use of a verification and maintenance mechanism in a product designing manufacturing process.

### BACKGROUND OF THE INVENTION

Due to the advances in modern technology, the traditional model of product manufacturing, which relied mainly on a massive human resource, has been enormously changed and gradually replaced by using powerful computers and machines. Therefore, from product design and development to the completion of product manufacture, even in the process of sales of the product to the customers, one can often see the aids of computers or machines. Although the costs of labor, time and money have been greatly reduced in the process of product design and product manufacture, to occupy the competitive market, business should spend the minimum amount of capital to produce a product which can best satisfy the demand of the market. For this reason, in order to adapt the competitive environment and the fast changing market demand, business should not only reorganize the structure thereof, but also develop new means of producing high quality, low cost products. The problem of how to more effectively exploit the related computer aided equipment and method in the process of product design and product manufacture than other competitors is an important topic.

In the aspect of engineering design change, a product of consumer electronics may contain hundreds or thousands of component parts. In the beginning of such engineering design, a bill of the required material for producing such a product is often listed by the R&D or design engineers, i.e. the Bill of Material (BOM). The content of the BOM includes at least the name, the part number, the quantity and the specification of each of the required component part of the product. However, changes of the content of the BOM is often necessary due to the shortage of component parts in stock, the performance of the component parts or the cost of the component parts. Once the change of the BOM is necessary, i.e. the engineering design change, it must be approved by the related engineering design departments. Otherwise, if the change is approved only by a portion but not all of the design engineers or the department managers, or at least not in a timely manner, disagreements between engineering design departments will be raised, thus the production efficiency and the quality of the product are thus affected.

In another aspect, there is no verification mechanism in the maintenance technology of the engineering data of the prior art. That is, when in the process of modifying the engineering data, some of the engineering data are often mistakenly changed, which are not supposed to be changed, due to some human factors. On the contrary, some of the engineering data are not changed while they are supposed to be changed. Moreover, there is no efficient mechanism for version maintenance in the prior art. That is, whenever an engineering data is changed, a new version of engineering data will be generated regardless of whether the engineering change data is approved by the related engineers or departments or not. Another words the many unapproved engineering change data confuses the user while looking them up. It is hard to estimate the amount of time wasted on such confusion.

### SUMMARY OF THE INVENTION

A primary objective of the present invention is to provide a method and a system for the maintenance of engineering change data to verify whether the engineering change data is changeable in the process of changing the engineering data.

Another objective of the present invention is to provide a method and a system for the maintenance of engineering change data to confirm whether the version of the engineering data are based on the approved engineering change data, thus, to reduce the unnecessary occupation of version sequence.

To achieve the foregoing and other objectives, the present invention of a maintenance system for engineering change data, then, comprises of: a database, to store the engineering change data, the data of BOM, the data of electronic forms, and the data of the responsible personnel or departments for the approval of the engineering change data; a form generation module, to generate an electronic form on the electronic information processing system based on the resultant data of the electronic form retrieved from the database by using some proper searching criteria in the electronic data processing system; a verification module, to compare in real time the engineering data before and after any modification while the user is changing the related engineering data via the electronic data processing system, and to generate an alert message for user reference if the user has changed any data which should not or can not be changed; a transfer module, to transfer the electronic forms to those responsible personnel or departments for approval, the data of which are retrieved from the database that matches the content of the engineering change data based on the engineering change data entered into the electronic data processing system; and a maintenance module, to save the newer version of the engineering change data, which has been approved through the transfer module, into the data base, and to distinguish the new engineering data from the engineering data before change.

The method for performing the maintenance of the engineering change data through the maintenance system of the engineering change data is described in the following. First, based on the position priority limit and the searching criteria entered into the electronic data processing system, the form generation module searches the database and retrieves the electronic form data that matches the criteria, and generates a electronic form for electronic change data maintenance, the user can thus perform the maintenance of engineering change data. Next, compare the engineering data before modification with the engineering change data entered by using the verification module to confirm if there is any change to those that should not be changed, generate an alert message if there is. Further, using the transfer module to transfer the electronic form of the engineering change to the related responsible personnel or departments and to perform related approval processes after the engineering change data entered into the electronic data processing system has been sent and confirmed. Finally, based on the engineering change data, which has completed the approval process, the database is updated and the version is upgraded by the maintenance module.

Comparing with the method and the system for maintaining the engineering change system of the prior art, the present invention of a method and a system for maintaining the engineering change system can verify whether the changes of the engineering data is changeable or not during the process of changing the engineering data. Moreover, it can also be used to confirm that only after the engineering change data is approved then the version of the engineering data can be changed, to reduce the unnecessary occupation of version sequence.

### BRIEF DESCRIPTION OF THE DRAWINGS

The present invention can be more fully understood by reading the following detailed description of the preferred embodiments, with reference made to the accompanying drawings, wherein:

FIG. 1 is a block diagram showing application structure of a system for maintenance of engineering change data according to the invention;

FIG. 2 is a block diagram showing system structure of the system for maintenance of engineering change data according to the invention; and

FIG. 3 is a flow diagram showing procedural steps for performing a method for maintenance of engineering change data according to the invention.

### DETAILED DESCRIPTION OF PREFERRED EMBODIMENTS

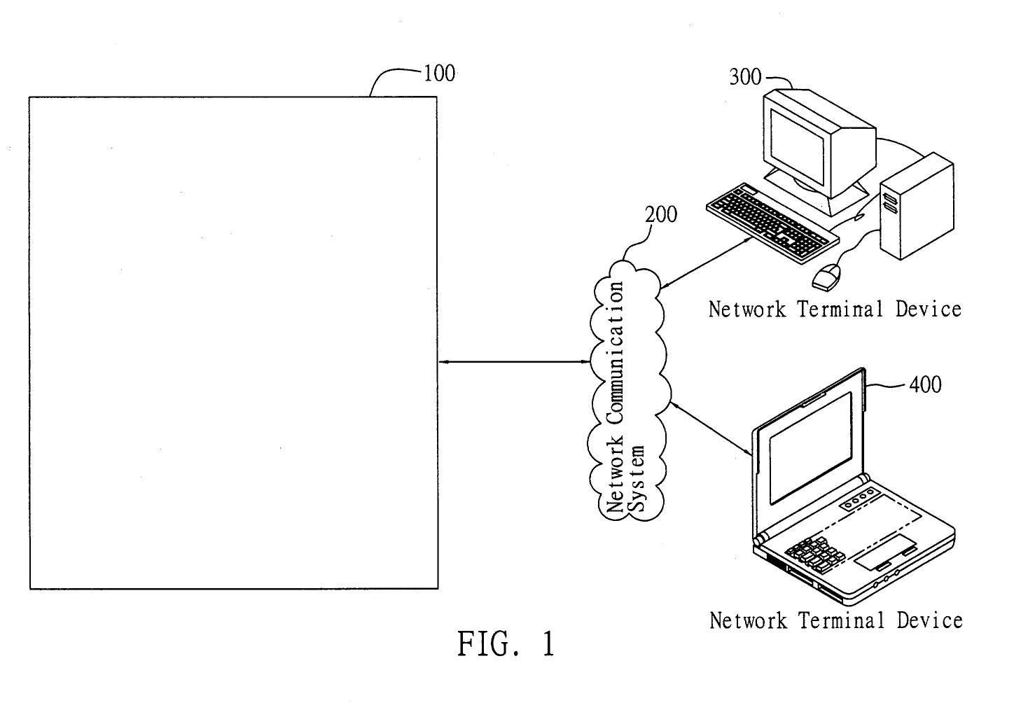

As shown in FIG. 1, the present invention of a maintenance system of the engineering change data 100 is applied on a network communication system 200 with a client-server structure. The maintenance system of the engineering change data 100 is built on the server end of the network communication system. The user of which can perform the works of transferring and receiving the related engineering change data by using a browser application program on the client ends of the network terminal device 300 and the network terminal device 400, that are capable of connecting to a network, to connect with the maintenance system of the engineering change data 100 on the server end via the network communication system 200. The network communication system 200 can be an Internet, an Intranet or an Extranet. The network terminal device 300 and the network terminal device 400 can be a Personal Computer (PC), a notebook computer (NB) or a Workstation. The browser application program can be the Internet Explorer of the Microsoft Company or the Netscape Navigator of the Netscape Company. Since the network communication system with client-server structure 200, the network terminal device and the browser described above are well-known hardware and software, the detailed description of which is neglected.

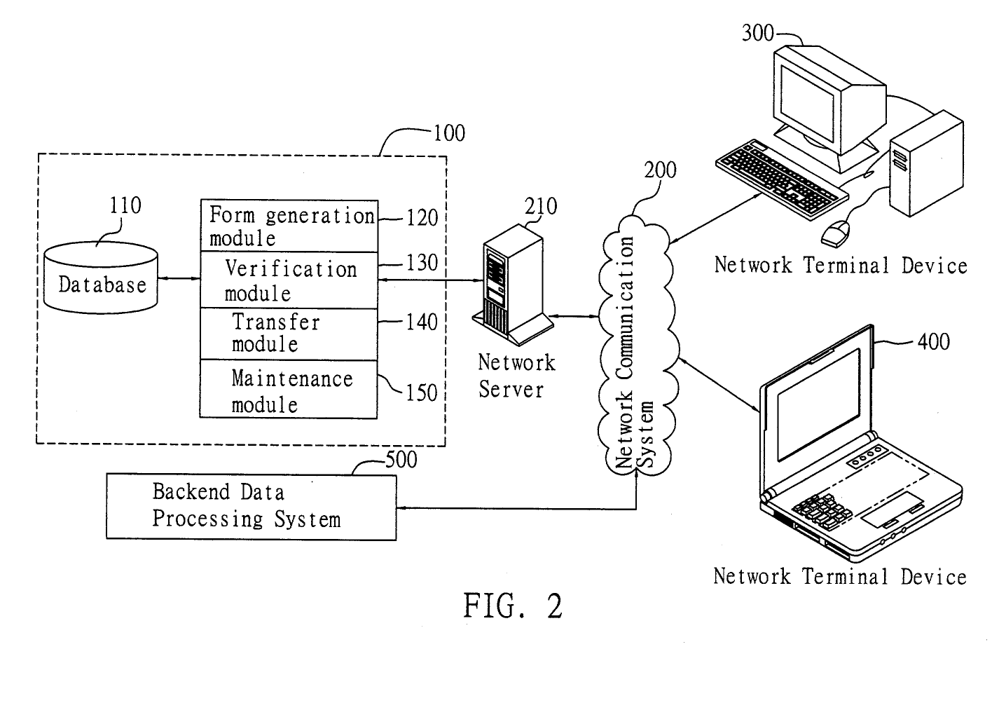

In FIG. 2, the system structure of the present invention of a maintenance system of the engineering change data 100 is shown. As shown in the figure, the maintenance system of the engineering change data 100 is accompanied with a network server 210. The network server 210 provides the maintenance system of the engineering data change a mean to connect with the network terminal device 300 and network terminal device 400. It also responds to the commands or other needs of the users on the network terminal device 300 and network terminal device 400 to access data. In this particular embodiment, the network terminal device 300 and the network terminal device 400 connects with the maintenance system of the engineering change data by using the network browser application program, the Internet Explorer of the Microsoft Company or the Netscape Navigator of the Netscape Company as described above, on the network terminal device to transfer, receive or access the related data of the engineering change via the network server system 210 through the network communication system 200. Moreover, the maintenance system of the engineering change data 100 is also connected with a backend data processing system 500 through the network communication system 200. The related data generated by the maintenance system of the engineering change data 100 can be stored in the backend data processing system 500. In this particular embodiment, the backend data processing system 500 can be an Enterprise Resource Planning (ERP) system or a Material Resource Planning (MRP) system.

The maintenance system of the engineering change data 100 is comprised of a database 110, a form generation module 120, a verification module 130, a transfer module 140 and a maintenance module 150.

The database 110 provides a mean for the maintenance system of the engineering change data 100 to store at least the engineering change data, the data of BOM, the data of electronic forms, and the data of the responsible personnel or departments for the approval of the engineering change data, entered by the user via the network terminal device through the network communication system 200. In this particular embodiment, in order to enhance the performance of data searching, the database 110 can be an associative database. The form of engineering change data includes the data entry fields for the originator of engineering design change, the content of the engineering design change, the corresponding department or personnel of the engineering change order after the engineering design change. The form of the data of BOM includes at least the data entry fields for the name, the part number, the specification and the quantity of each component part of the product. The form of the data of electronic form includes at least the data entry fields for the serial number of the electronic form and each of the file with the format of the electronic form. The form of the data of the responsible personnel or departments for the approval of the engineering change data includes at least the data entry fields for the name, the position, the employee number, the e-mail address and the name of the department of the responsible personnel for processing the engineering change order.

Through the construction of this kind of associative database, the maintenance system of the engineering change data 100 can quickly find the corresponding data provided that one of the above data is entered. Notice that the above mentioned data entry fields and the data forms are for illustrative purposes only, the content of which should be more precise and more in detail in the realistic cases. Moreover, the content of the data entry fields is also possible to include other data entry fields or data lists. Only the data related to the maintenance of the engineering change data is shown for clarity and simplicity. On the other hand, there is also a multiple of system structures for the associative database, the construction of which is a well-known technology, the description of which is thus neglected.

According to the searching criteria of the data of the electronic form and the user identification entered by the user through the network terminal device, the form generation module 120 finds the data of electronic form from the database 110 which matches the searching criteria and the user's priority limit. It generates accordingly an electronic form on the display unit of the network terminal device, so that the user can enter the related content of the engineering change data via the input unit, e.g. keyboard or mouse, on the network terminal device. In this particular embodiment, the content of the engineering change electronic form can be the engineering change notification, the material list change notification and the material change notification. These correspond to the change of engineering data in different engineering levels, wherein the engineering change notification is provided to change the engineering data for the users in the R&D level. The material list change notification and the material change notification is provided to change the engineering data for the users in the manufacturing level at each production factory. Moreover, after the data of the engineering change is completely entered and confirmed, the engineering change data will be stored in the database 110, and, if necessary, stored in the backend data processing system 500.

While the user is changing the related engineering data through the network terminal device, the verification module 130 compares, in real time, the engineering data before and after the change, and generates an alert message for user reference if there is any change that should not or can not be changed. In this particular embodiment, suppose a user of the maintenance system of the engineering change data at one production factory wants to change the engineering data by sending out the material list change notification described above. The engineering data of the component part A in manufacturing line 1 is to be replaced by the component part A in the manufacturing line 2, however, the quantity of which needs not to be changed. Before changing the above mentioned engineering data, the verification module 130 compares, in real time, the quantity of the component part A in the engineering data before and after the change. Since the quantity of the component part A, described above, should not and can not be changed, the verification module 130 generates immediately an alert message once the quantity of the component part A is accidentally changed by the user. The unusual change can thus be notified and an error in the engineering change can be prevented from happening.

According to the content of the engineering change data entered from the input unit of the network terminal device, the transfer unit 140 finds, from the database 110, the data of the responsible personnel and departments for approving the engineering change data, which matches the content of the engineering change data. In this particular embodiment, suppose the format of the electronic form includes the data of the responsible personnel and departments for the approval of the related engineering change data, the transfer module 140 finds, from the database 210, the data, e.g. the e-mail addresses, of the responsible personnel and departments for the approval of the related engineering change data and the default transfer flow, then, based on the default transfer flow, the engineering change data can be transferred and approved.

The maintenance module 150 stores a newer version of the engineering change data, which has been approved through the transfer module, into the database to distinguish the engineering data before change. In this particular embodiment, the database 110 stores the original engineering data, as well as the engineering change data, based on the original engineering data. Consequently, the version sequence of the original engineering data is the first version, and the version sequence of the engineering change data is the second version, and so on. The maintenance module 150 will justify whether the engineering change data has completed the approval process or not. If the engineering change data has completed the approval process, the maintenance module 150 will define the engineering change data as a newer version and store the engineering change data into the database 110. On the contrary, provided that the approval process is not completed, the maintenance module 150 will still store the changed engineering data into the database, however, no version number will be added to the engineering change data. This will prevent the invalid engineering change, which is not approved, from occupying the version sequence. The changed data can also be sent to the backend data processing system 500 according to the needs of the user.

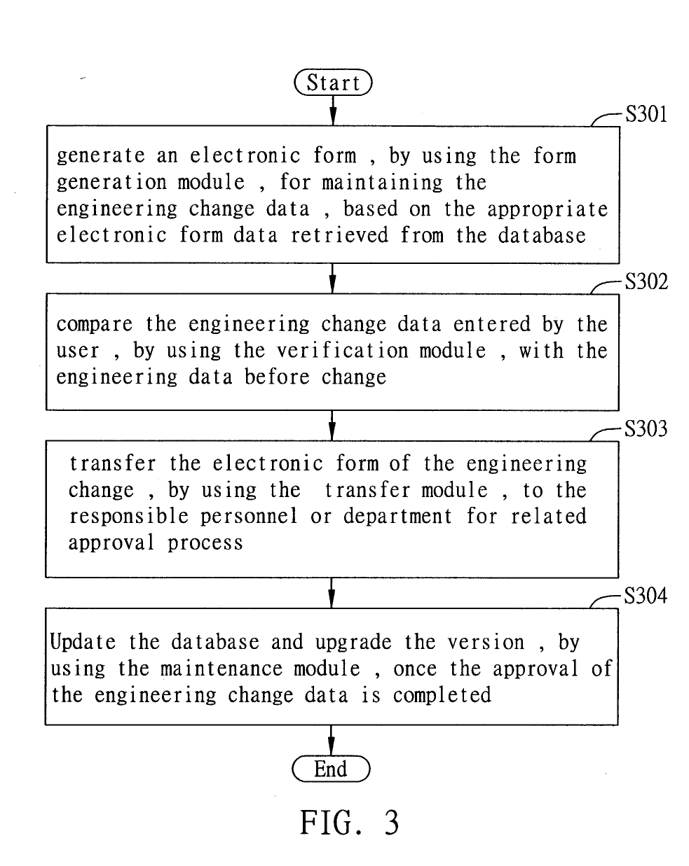

In FIG. 3, the steps of the method for maintaining the engineering change data through the maintenance system of the engineering change data 100 are described as the following.

In step S301, the form generation module 120 generates a electronic form for maintaining the engineering change data based on the data of electronic form retrieved from the database 110 by matching the position priority limit and the searching criteria entered from the network terminal device, so that the user can maintain the engineering change data. As described above, in this particular embodiment, suppose the user, who is in charge of the manufacturing planning, wants to change the engineering data for some product and needs to send out a material list change notification, the user should first enter the data of the product, e.g. the name and the serial number of the product, and the data of personal identification, e.g. the user name or the employee number. The form generation module 120, then received the data, finds the corresponding data by searching the database 110, and generates an electronic form of the corresponding material list change notification. Then, the electronic form is sent to the network terminal device of the user via the network communication system 200, so that the user can modify the engineering data via the network terminal device, and proceed to step S302.

In step S302, the verification module 130 compares the engineering data before and after change if there is any change that should not or can not be changed an alert message is generated. As described above, while the user is changing the engineering data of the material list via the input unit of the network terminal device, the verification module 130 can compare, in real time, whether there is any change which should not or can not be changed or not. An alert message is generated if there is any for user reference. In this particular embodiment, in order to change the engineering data, the user should send out an above mentioned material list change notification. The engineering data is to be changed from the component part A in the manufacturing line 1 to the component part A in the manufacturing line 2, however, the quantity of which is not to be changed. The verification module 130 compares, in real time, the quantity of the component part A before and after the change. Since the quantity of the component part A should not and can not be changed, once the user accidentally changed this part, the verification module will generate an alert message which is sent to the network terminal device of the user via the network communication system 200, so that the unusual change can be notified and an error in the engineering change can be prevented from happening, and then proceed to step S303.

In step S303, the transfer module 140 transfers the electronic form of the engineering change to the related responsible personnel or departments for approval after the engineering change data, entered by the user through the network terminal device, is sent and confirmed. As described above, after the verification module 130 has confirmed the content of the material list change notification, entered by the user through the network terminal device, to be correct, the transfer module 140 retrieves the data, e.g. the e-mail address, of responsible personnel and departments for the approval of the engineering change data based on the data of the responsible personnel and departments for the approval of the engineering change data and the default transfer flow corresponding to the responsible personnel and departments entered by the user. Then, based on the default transfer flow to transfer the related engineering change data, so that the responsible personnel and departments can perform the approval process, then proceed to step S304.

In step S304, the maintenance module 150 updates the database 110 and upgrades the version based on the engineering change data, of which the approval is completed. As described above, in this particular embodiment, suppose the material list change notification is sent for the first time and the related personnel have completed the approval of the material list change notification, the changed content of the material list can then be defined as the second version. After the completion of approval for the material list change notification is confirmed, the material list can thus be defined as the second version by the maintenance module 150 define and stored into the database 110. Moreover, the changed data can also be transferred to the backend data processing unit 500 according to the need of the user.

In summary, the present invention of a method and a system for maintaining the engineering change data can, in the process of changing the engineering data, verify whether the changed engineering data should be changed or not. Moreover, the present invention can be used to change the version of the engineering data only after the approval of the engineering change data is confirmed, so that the unnecessary occupation of version sequence is avoided.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A method for maintenance of engineering change data for allowing a user to maintain engineering change data via a network terminal device and a network communication system, the method comprising the steps of:
having a form generation module search electronic form data from a database according to access rights and search conditions entered from the user via the network terminal device and generate an electronic form for maintenance of engineering change data based on the searched electronic form data from the database to which electronic form the user enters the engineering change data via the network terminal device;
having a verification module compare engineering data before and after being modified by the user via the network terminal device to determine if engineering data, which are unexpected to be changed, are modified by the user; if yes, generating an alert message to confirm this modification with the user;
having a transfer module transfer the electronic form with the engineering change data to an associated responsible unit for verification and approval after the engineering change data are confirmed and sent by the user via the network terminal device; and
having a maintenance module update and upgrade version of engineering data in the database and a backend data processing system once the engineering change data are verified and approved.

2. The method of claim 1, wherein the network terminal device is a workstation, personal computer (PC), notebook computer, palm computer, personal digital assistant (PDA), or cellular phone.

3. The method of claim 1, wherein the network communication system is Internet, Intranet, or Extranet.

4. The method of claim 1, wherein the network communication system is a cable or wireless communication system.

5. The method of claim 1, wherein the backend data processing system is an Enterprise Resource Planning (ERP) system or a Material Resource Planning (MRP) system.

6. The method of claim 1, wherein the engineering change data comprise an engineering change notification, a material list change notification, or a material change notification.

7. The method of claim 1, wherein the database is an associative database.

8. A system for maintenance of engineering change data for allowing a user to maintain engineering change data via a network terminal device and a network communication system, the maintenance system comprising:
a database for storing engineering data including at least engineering change data, material data, electronic form data, data of responsible units for verifying and approving the engineering change data;
a form generation module for searching electronic form data from the database corresponding to search conditions entered from the user via the network terminal device and for generating an electronic form for maintenance of engineering change data according to the searched electronic form data, the electronic form being displayed on the network terminal device to which electronic form the user enters engineering change data via the network terminal device;
a verification module for comparing in real time engineering data before and after being modified by the user via the network terminal device to determine if engineering data, which are unexpected to be changed, are modified by the user; if yes, generating an alert message to confirm this modification with the user;
a transfer module for obtaining an associated responsible unit from the database according to the engineering change data entered by the user via the network terminal device and for transferring the engineering change data to the responsible unit for data verification and approval; and
a maintenance module for storing the verified and approved engineering change data in the database to be distinguished from those before being modified, and for transferring the engineering change data to a backend data processing system for data management depending on the user's requirement.

9. The system of claim 8, wherein the network terminal device is a workstation, personal computer (PC), notebook computer, palm computer, personal digital assistant (PDA), or cellular phone.

10. The system of claim 8, wherein the network communication system is Internet, Intranet, or Extranet.

11. The system of claim 8, wherein the network communication system is a cable or wireless communication system.

12. The system of claim 8, wherein the backend data processing system is an Enterprise Resource Planning (ERP) system or a Material Resource Planning (MRP) system.

13. The system of claim 8, wherein the engineering change data comprise an engineering change notification, a material list change notification, or a material change notification.

14. The system of claim 8, wherein the database is an associative database.
